(19) United States
(12) Patent Application Publication
(10) Pub. No.: US 2010/0243570 A1
(43) Pub. Date: Sep. 30, 2010

(54) METHOD, INSTALLATION AND SYSTEM FOR MEASURING AND/OR TREATING CONTAMINATING COMPOUNDS DISSOLVED IN A LIQUID

(76) Inventors: Mateo Jozef Jacques Mayer, Amersfoort (NL); Johannes Kuipers, Hantum (NL); Maarten Markus Nederlof, Veenendaal (NL); Sybrandus Jacob Metz, Heerenveen (NL)

Correspondence Address: MEDLEN & CARROLL, LLP, 101 HOWARD STREET, SUITE 350, SAN FRANCISCO, CA, 94105, US

(21) Appl. No.: 12/450,221

(22) PCT Filed: Mar. 17, 2008
(86) PCT No.: PCT/NL2008/000082

§ 371 Date: Jun. 18, 2010

(30) Foreign Application Priority Data
Mar. 16, 2007 (NL) 1033545
Aug. 15, 2007 (NL) 1034253

(51) Int. Cl. C02F 1/52; C02F 1/48; C02F 1/36; C02F 1/42; G01N 15/06

(52) U.S. Cl. 210/665; 210/748.01; 210/695; 210/748.03; 210/748.04; 210/748.05; 210/541; 210/205; 210/143; 73/61.71

(57) ABSTRACT

The present invention relates to a method, device and system for measuring and/or treating contaminating components dissolved in a liquid in a liquid flow, such as in a water treatment, the method comprising the steps of: —carrying at least a part of the liquid from the liquid flow with contaminating components present therein into a container or a conduit; —causing precipitation of at least a part of the dissolved contaminating components, wherein solid particles are formed, and/or treating the quantity of process liquid; optionally followed by: —measuring the presence and/or the quantity of solid particles formed.

The present invention relates to a method for measuring contaminating components dissolved in a liquid in a liquid flow, such as in a water treatment.

In for instance purification processes, for instance in water treatments, a liquid flow is divided into a purified flow and a concentrated waste flow. Owing to the accumulation of contaminating components in the process there is a chance of the solubility limit of some of these contaminating components in the process being exceeded. This results in scaling which can result in a higher energy consumption, a lower production capacity, more maintenance and a shorter lifespan of the process installations. The danger of this scaling is prevented in practice by adding a quantity of crystal growth inhibitor to the liquid flow. This additive prevents the growth of the crystals which can cause said scaling. If such additives are added in excess, they can enter the environment and/or require additional treatment steps. In the case the dosage is too low, there is still the danger of scaling in the process installation, with the above stated drawbacks.

The present invention has for its object to provide a method with which, among other objects, the required additives can be adapted to the need and with which the process can be operated more efficiently.

This objective is achieved with the method according to the invention, comprising the steps of:
carrying at least a part of the liquid from the liquid flow with contaminating components present therein into a container or a conduit;
causing precipitation of at least a part of the dissolved contaminating components, wherein solid particles are formed; and
measuring the presence and/or the quantity of solid particles formed.

By causing precipitation of at least a part of the contaminating components dissolved in the liquid flow solid particles are formed in the relevant part of the liquid flow. Measurement of the formed particles can take place directly, but also indirectly. In addition to the quantity of particles, the size of the particles and/or the shape and/or the crystal modification can also contain relevant information concerning the danger of scaling in for instance a process installation. Measurement of the particles can therefore also relate to for instance this information. The contaminating components include, among others, barium sulphate, calcium sulphate, struvite, magnesium hydroxide, magnesium sulphate, silicates and strontium sulphate. The calcium sulphate may here include, among other products, gypsum which is stable at room temperature and anhydrite which is stable at higher temperatures. Causing precipitation of at least a part of said components can be performed on the whole liquid flow in for instance the regular transport conduit for the liquid in question. The precipitation is preferably performed on a part of the liquid. This is realized by carrying a part of the liquid into a container or conduit. Such a conduit can for instance be a part of the feed conduit or a type of bypass conduit. Such a bypass conduit has for instance a diameter of 1-100 μm. The diameter of the conduit can also be from several centimetres to the order of magnitude of one metre if a larger measurement cell is chosen or the invention is applied on production scale. Another possibility is to apply the invention in a retention time reactor. It is possible to measure the formed particles by causing precipitation of at least a part of the contaminating components in at least a part of the liquid from the liquid flow. The accuracy of the measurement depends here, among other factors, on the quantity of liquid. In a preferred embodiment the measurement is performed with a so-called turbidity meter. Such a meter emits a light beam or laser beam through the liquid with the solid particles formed therein. The intensity of the light beam is then measured by a detector, wherein the measured intensity is a measure of the quantity of solid particles in the liquid. In an alternative preferred embodiment use is made of sonoluminescence. The emitted light formed under the influence of the ultrasonic sound is used here to detect the particles. In a further alternative preferred embodiment the dielectric constant of the relevant fluid is measured. This dielectric constant is for instance measured by applying a voltage difference between which is situated liquid with the solid particles formed therein. Since the surface and the distance between these poles is fixed, a variation that is measured will be caused by a change in the dielectric constant of the liquid between the two poles. For the different materials this dielectric constant is expressed relative to the dielectric constant of vacuum which is physically constant. For water this relative dielectric constant lies in the order of magnitude of 80. A value of around 8 applies for calcium carbonate, which is a relevant substance in, among others, water treatment processes. The risk of scaling in the further process can be precisely assessed by performing such a measurement. Crystals can also be distinguished from organic particles such as micro-organisms, since these particles consist largely of water and therefore have a greater dielectric constant than most inorganic particles. In respect of scaling with for instance calcium carbonate influential factors are, in addition of course to the concentration of calcium and carbonate ions, the temperature, the pH, the presence of traces of other contaminants, even at ppm level, and among other factors also the type and the concentration of crystal growth inhibitor in the liquid. This therefore means that a scaling measurement according to the invention, which takes into account all factors occurring in the liquid flow, can more accurately determine the risk of scaling in the further course of the process than for instance a measurement of only the concentration of calcium and carbonate ions. The measurement is preferably performed on-line here in order for instance to use the measured value in the process control.

In a preferred embodiment according to the present invention the formation of the solid particles comprises of applying a vibration field.

Primary nucleation can be induced in a supersaturated solution by applying a vibration field. This is realized in that the vibration field generates pressure waves which result in microscale cavitation in the liquid. This will result in the formation of small vapour bubbles and high local temperature gradients. The solubility of at least a part of the contaminating components in the liquid of the liquid flow hereby changes, whereby nuclei can be formed (primary nucleation). It is noted that the use of ultrasonic vibrations to induce nucleation is not limited to components whose solubility decreases as temperature increases. These nuclei or solid particles will make the liquid to some extent turbid and/or cause a change in the electrical properties. This makes measurement of the concentration of contaminating components in the liquid flow difficult. In a preferred embodiment according to the invention the vibration field is applied with acoustic vibrations in a frequency range of preferably 10 kHz to 1 MHZ, or for instance in a frequency range of 10 kHz to 100 kHz and/or 100 kHz to 500 kHz and/or 500 kHz to 1 MHZ. It is noted that vibrations at higher frequencies up to 1 GHz can also be applied according to the invention. Because with a correct selection of process conditions the formed solid particles have relatively small dimensions at which, at least for the duration of the measurement, they do not settle or precipitate in a significant quantity, and remain suspended in the liquid, the supersaturation can be determined from the measured concentration of formed particles. The effect of the force of gravity is limited. The so-called Brownian movement contributes toward preventing settling of the solid particles. An additional advantage of applying such a vibration field is that, through the choice of the frequency employed, a measurement can be made specifically for (a group of) determined components. The reliability of the measurement can also be increased through the choice of frequency. An additional advantage is that depositions on the wall of the conduit can be avoided by applying such ultrasonic vibrations. The relevant sensor is for instance hereby less, or not at all, likely to become fouled. In the case of, among others, water treatment processes the liquid used often comprises diverse micro-organisms. An additional advantage is that such micro-organisms can be eliminated through the use of ultrasonic vibrations and the cell content of such organisms can be released. This results in components such as phospholipids being distributed through the liquid in to some extent homogeneous manner. The liquid characteristics can hereby be changed. An example hereof is that the organic components which enter a liquid due to such an elimination can act as inhibitor for the crystal growth. This has the further additional advantage that the risk of scaling is further reduced. In addition to measuring the risk of scaling, and the adjustment of the quantity of crystal growth inhibitor to be added which has become possible as a result, this therefore further counteracts scaling. Even less crystal growth inhibitor will therefore need to be added. The environmental impact associated with the extra addition will hereby be minimized. The process can also be operated more efficiently. Other components present in the liquid flow can also be degraded in addition to the micro-organisms.

In an alternative preferred embodiment according to the present invention the formation of solid particles comprises of applying an electric or magnetic field.

The behaviour of the liquid, for instance in respect of the solubility of components in this liquid, can be influenced by applying an electric or magnetic field in at least a part of the liquid in the liquid flow. The free energy for forming of solid particles will change by for instance applying a field strength above 10⁵ V/m. At least a part of the contaminating components dissolved in the saturated solution can hereby precipitate in the liquid. The concentration of formed solid particles can then be measured using for instance a turbidity meter or by measuring the dielectric constant of the liquid. The whole measurement can be performed on either the whole liquid flow or on a part thereof, optionally in a part of the transport conduit or a bypass thereof. In a preferred embodiment such a bypass is embodied in glass onto which metal is vapour-deposited. Such metal strips serve as poles over which a voltage is applied such that for instance the electric field is formed in the liquid. If desired, a metal can herein be arranged on the outer side or on the inner side of the conduit. The application of an electric field can make use of direct voltage, alternating voltage at different frequencies, direct voltage with an alternating voltage superimposed etc. Although in a preferred embodiment said field strength lies above 10⁵ V/m, the strength is preferably higher than 10⁴ V/m and preferably lower than 10⁸ V/m, and in any case lower than the field strength above which so-called breakdown occurs. For the purpose of applying the electric field use can be made of an alternating voltage in which a frequency lies in the frequency range of 0 to 10 GHz, and preferably in the range of 0 to 100 kHz and/or of 100 to 1000 kHz and/or of 1 MHZ to 100 MHZ and/or of 100 MHZ to 10 GHz.

In a preferred embodiment according to the present invention the frequency and/or amplitude and/or form of the vibrations to be applied can be set with setting means.

By manipulating the applied vibrations the measurement can be performed specifically for instance for supersaturation of calcium carbonate at a specific moment in the liquid flow. If desired, the presence of other components can be measured by modifying the diverse settings for the applied vibrations. The sensitivity of a sensor can also be influenced by the correct setting of for instance the amplitude, the frequency, frequency spectrum, time duration and form of the vibration signal, in order to thereby realize for instance a desired margin of safety for the prediction of the scaling in the process.

It is further noted that diverse micro-organisms and/or contaminants such as humic acids which are usually biologically less readily degradable are generally present in a liquid flow in the process industry, such as for instance for a water treatment. This presence is usually undesirable in respect of the quality of the end product. Nor do these components usually contribute to the efficient operation of the process in question.

The above outlined problem is solved with the method according to the invention for treating a quantity of process liquid, comprising the steps of:
carrying a quantity of process liquid with contaminating components therein into a container or a conduit;
applying a treatment field formed by a vibration field or an electric or magnetic field; and
treating the quantity of process liquid, comprising of:
   eliminating micro-organisms; and/or
   degrading organic material; and/or
   forming crystals from the contaminated components.

Micro-organisms will be eliminated by treating the process liquid with a vibration field or an electric or magnetic field. The cell content of these organisms is hereby released. These are, among others, phospholipids which will influence the crystallization/properties of the liquids. These components, which in this way are distributed homogeneously in the liquid, will usually have the effect of inhibiting crystal growth. The risk of scaling in a process installation is hereby reduced. A further result is that less crystal growth inhibitor need be added. This will reduce the environmental impact and result in a more efficient operation of the process. In addition to micro-organisms, the process liquid, such as for instance untreated water in the case of water treatment, comprises macromolecules such as humic acids which are biologically less readily degradable. Just as other organic molecules, these components can be at least partially decomposed by the high local temperatures that are formed. The resulting decomposition products are usually less undesirable than macromolecules which are difficult to degrade. In addition, the formed components can even function as crystal growth inhibitor, resulting in the above stated advantages. It is also possible with the treatment to cause precipitation of specific components such as calcium carbonate, for instance for the purpose of the actual purification of the liquid flow. The risk of scaling in the further process can hereby be further reduced. In a preferred embodiment according to the present invention use is made of an acoustic vibration field in similar manner as elucidated for the method for measuring the risk of scaling.

In a preferred embodiment according to the present invention a crystal growth inhibitor is added during the treatment of process liquid for the purpose of adsorbing formed crystals.

It is noted that it is possible to reduce supersaturation to below the solubility of the component for precipitating. By adding a crystal growth inhibitor which adsorbs to the precipitate (a so-called retarding agent) it is possible to counter dissolution of these crystals so that they can for instance be separated from the liquid. The result is then for instance softened water with a calcium and carbonate content below the solubility limit. It is noted that this technology has a wide field of application in the process industry and that the invention is not limited to the softening of water.

The invention further relates to a device and to a system for measuring and/or treating contaminating components dissolved in liquid. Such a device or system provides the same effects and advantages as those stated with reference to the methods.

Further advantages, features and details of the invention are elucidated on the basis of preferred embodiments thereof, wherein reference is made to the accompanying drawings, in which:

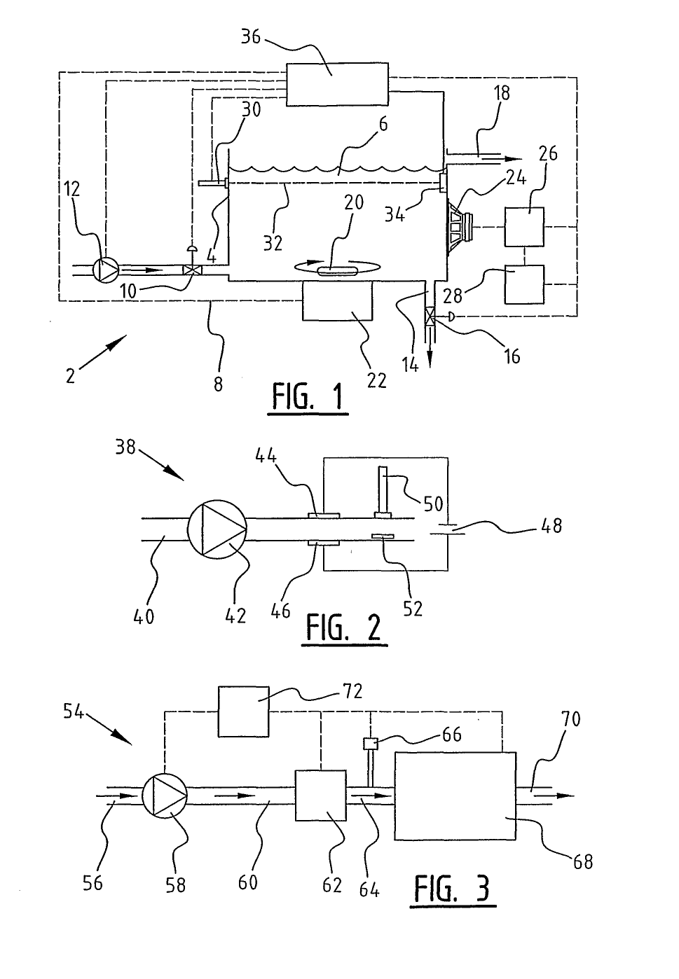

FIG. 1 shows a schematic overview of a device according to the invention;

FIG. 2 shows an alternative embodiment according to the invention; and

FIG. 3 shows a schematic overview of a process provided with the invention.

A measurement setup 2 (FIG. 1) for measuring the quantity of contaminating components in a quantity of liquid comprises a container 4 in which liquid 6 is arranged. Liquid 6 comprises water with the components dissolved therein. Container 4 is filled with liquid 6 through a feed conduit 8 in which a valve 10 and a pump 12 are provided. Container 4 can be emptied via discharge 14 in which a valve 16 is provided. An overflow 18 is provided to prevent overflow of container 4 with liquid 6. Provided for the purpose of homogenizing liquid 6 in container 4 is stirrer 20 which is set into operation by drive 22. An acoustic vibration is applied in liquid 6 by sound box 24 which is driven by an amplifier 26. Amplifier 26 receives a signal from signal former 28 with which, among other settings, the frequency, amplitude and form of the applied vibration field can be set. The primary particles formed by the primary nucleation can be measured using a sensor 30. This sensor 30 emits a light beam or laser beam 32 through liquid 6. Detector 34 receives beam 32, wherein the intensity received by detector 34 is a measure of the quantity of formed particles. The measurement is then sent to control unit 36 which processes the data and can, if desired, control the process. For this purpose control unit 36 is coupled operatively to amplifier 26, signal former 28, pump 12, sensors 30 and 34 and valves 10, 16.

Control unit 36 controls pump 12 and valve 10 for the purpose of carrying a quantity of liquid 6 into container 4. If desired, stirrer 20 can be set into operation by actuating drive 22. Control unit 36 will then start the vibration field by having signal former 28 send a signal to amplifier 26, which processes and sends the signal to box 24. The nucleation induced by the vibrations results in a change in the turbidity of liquid 6, whereby a light beam 32 emitted by sensor 30 will be received with less intensity by detector 34. Sensor 30 and detector 34 are connected to control unit 36 for exchange of information. Control unit 36 then analyses the data and determines the risk of scaling at which primary nucleation occurs, and optionally the properties of the formed nuclei in addition to possible other required data. If desired, an acoustic vibration at a relatively high power can be applied pulse-wise to the liquid via control unit 36. Even higher temperature gradients can hereby be applied in the liquid compared to a more uniform distribution of the same amount of energy through time. In the shown embodiment container 4 has dimensions of 40×20×25 cm. Signal former 28 operates in the range of 10 to 100 kHz and generates for instance a pure sine-wave signal to amplifier 26 which has a power of 50 to 100 W. Amplifier 26 controls a piezoelectric element or loudspeaker (tweeter) 24 which has a power of 50-500 W. In the shown embodiment a power of several watts will be applied in the liquid. It will be apparent to the skilled person that nucleation can also be realized with much lower power and that the desired supplied power depends on the dimensions of the sensor. In addition to a pure sine-wave signal, a noise signal, even white noise signal, can be applied, as well as a sawtooth or block voltage. An actuator is preferably used which does not operate at a resonance frequency but in a frequency range.

An alternative measurement system 38 (FIG. 2) comprises a feed conduit 40 with a pump 42 for feeding a liquid through conduit 40. Conduit 40 is embodied in glass on which two poles 44 and 46 in the form of metal have been vapour-deposited. This vapour-deposition can also be performed on the inner side of conduit 40. By applying an electric field in the supersaturated solution in conduit 40 with field strength higher than about 10⁵ V/m the free energy for forming solid substance falls provided there is a positive difference in the dielectric constant between the liquid and the relevant solid. In the presence of the field strength primary nucleation is generated in the flow between the two poles or capacitor plates 44 and 46. This can be measured with, among other components, a sensor 50 and detector 52 since the liquid becomes somewhat turbid as a result of the nucleation. The required voltage on capacitor plates 44 and 46 is applied by voltage source 48 in the form of an alternating voltage, direct voltage or combination thereof.

A process 54 such as a water treatment process comprises a feed conduit 56 with a pump 58 provided therein (FIG. 3). Pump 58 sends the liquid flow via throughfeed conduit 60 to sensor system 62. This sensor system 62 measures and/or treats the liquid flow coming from throughfeed conduit 60 and feeds it through via throughfeed conduit 64 to the relevant process 68. An adding system 66 is provided prior to process 68. In the case of a water treatment, adding system 66 will be able to add a crystal growth inhibitor to the liquid flow. This prevents scaling in the (purification) process 68. The outflow of process 70 will then comprise less unnecessary additive.

The present invention is by no means limited to the above described preferred embodiments. The rights sought are defined by the following claims, within the scope of which many modifications can be envisaged. In addition to use for instance for water treatment, it is possible to apply the methods, device and system according to the invention to for instance a brewing process. Here the water must usually be as pure as possible for use in the actual brewing process. Possible contaminants must be known as far as possible and treated. The use of excess crystal growth inhibitor must be avoided as far as possible. The measuring and/or treating of a liquid flow is therefore highly relevant for such a process. The methods, device and system according to the invention can also be applied in the chemical industry. It is thus possible for instance to initiate nucleation on production scale and in this way to start or sustain a crystallization process in controlled manner. It is also possible to have the sensors emit such laser beams for the purpose of more or less trapping for instance a bacteria. For this purpose use is made of so-called optical tweezers. By focusing these laser beams at one point a strong electric field is created within which particles can be held. An individual crystal can then be studied by for instance then inducing and monitoring crystal formation. It is likewise possible to place a plurality of sensors in parallel or in series. Specific measurements can for instance hereby be performed on different components and the amount of information obtained about the liquid flow can hereby be increased. By making use of the present invention it is for instance possible in the case of a water treatment to form very small primary calcium carbonate nuclei and reduce the supersaturation of the process flow. Through a correct choice of the process conditions the formed nuclei remain so small that no scaling or blockage will occur in the so-called RO unit. By then treating the concentrate from this unit with ultrasonic vibrations according to the present invention and optionally recirculating it, it is in principle possible to produce drinking water by means of a reverse osmosis process without making substantial use of a water softening and without use of a crystal growth inhibitor. Using the methods, device and system according to the present invention it is further possible to produce water to a specification. This can be particularly advantageous for the use for instance for washing machines by pretreating the water. Scaling in such appliances can hereby be reduced.

1. A method for measuring contaminating components dissolved in a liquid in a liquid flow, such as in a water treatment, comprising the steps of:
carrying at least a part of the liquid from the liquid flow with contaminating components present therein into a container or a conduit;
causing precipitation of at least a part of the dissolved contaminating components, wherein solid particles are formed; and
measuring the presence and/or the quantity of solid particles formed.

2. Method as claimed in claim 1, wherein the formation of the solid particles comprises of applying a vibration field.

3. Method as claimed in claim 2, wherein the vibration field is applied be applying acoustic vibrations in the process liquid in a frequency range of 10 kHz to 10 GHz.

4. Method as claimed in claim 1, wherein the formation of solid particles comprises of applying an electric or magnetic field.

5. The method as claimed in claim 2, wherein a frequency and/or an amplitude and/or a form of the vibrations to be applied is set with setting means.

6. The method as claimed in claim 1, wherein the quantity of formed primary particles is measured with a turbidity meter.

7. The method as claimed in claim 1, wherein the quantity of formed primary particles is determined by measuring the dielectric constant of the process liquid.

8. A method for treating a quantity of process liquid, comprising the steps of:
carrying a quantity of process liquid with contaminating components present therein into a container or a conduit;
applying a treatment field formed by a vibration field or an electric or magnetic field; and
treating the quantity of process liquid, comprising of:
eliminating micro-organisms; and/or degrading organic material; and/or
forming crystals from the contaminated components.

9. Method as claimed in claim 8, wherein the vibration field is formed by applying acoustic vibrations.

10. The method as claimed in claim 8, wherein a crystal growth inhibitor is added during the treatment of the process liquid for the purpose of adsorbing formed crystals.

11. A device for measuring and/or treating contaminating components dissolved in a liquid in a liquid flow, such as in a water treatment, comprising:
a container or conduit with a quantity of process liquid in which a quantity of contaminating components is present; and
nucleating means for causing precipitation of at least a part of the dissolved contaminating components.

12. Device as claimed in claim 11, wherein the nucleating means comprise a vibrating member for applying an acoustic vibration field in the process liquid.

13. A system for measuring and/or treating a quantity of process liquid, comprising:
a device as claimed in claim 11, and
a control unit connected operatively to the device for controlling the measurement and/or treatment of the process liquid.
